(19) United States
(12) Patent Application Publication
(10) Pub. No.: US 2013/0258452 A1
(43) Pub. Date: Oct. 3, 2013

(54) LIGHT DEFLECTING ELEMENT

(71) Applicants: Yuuzo KAMIGUCHI, Kanagawa (JP); Masahiro Kanamaru, Kanagawa (JP); Katsuya Sugawara, Kanagawa (JP); Keiichiro Yusu, Kanagawa (JP); Masatoshi Sakurai, Tokyo (JP)

(72) Inventors: Yuuzo KAMIGUCHI, Kanagawa (JP); Masahiro Kanamaru, Kanagawa (JP); Katsuya Sugawara, Kanagawa (JP); Keiichiro Yusu, Kanagawa (JP); Masatoshi Sakurai, Tokyo (JP)

(21) Appl. No.: 13/730,321

(22) Filed: Dec. 28, 2012

(30) Foreign Application Priority Data
Mar. 27, 2012 (JP) 2012-071512

(51) Int. Cl. G02F 1/29

(52) U.S. Cl. CPC G02F 1/29
USPC 359/315

(57) ABSTRACT

According to an embodiment, a light deflecting element includes a dielectric body, a first electrode, a second electrode, and a third electrode. Each of the second electrode and third electrode is configured to sandwich the dielectric body with the first electrode. The second electrode includes an electrode having a side that lies substantially orthogonal to an incident direction of a light beam, a side that is substantially parallel to the incident direction, and a side that intersects with the incident direction. The third electrode includes an electrode having a side that is aligned with the second electrode, a side that is substantially parallel to an incident direction of the light beam, and a side that intersects with the light beam, and that slopes in an opposite to that of the side of the second electrode that intersects with the light beam.

### CROSS-REFERENCE TO RELATED APPLICATION

This application is based upon and claims the benefit of priority from Japanese Patent Application No. 2012-071512, filed on Mar. 27, 2012; the entire contents of which are incorporated herein by reference.

### FIELD

Embodiments described herein relate generally to a light deflecting element.

### BACKGROUND

It is a known fact that a light deflecting element is formed with the use of a material having an electro-optic effect so that the incident light can be deflected and output without having to use a mechanically movable member.

However, with conventional technology, it is not possible to deflect a gathered light such as an optical spot at high speed.

### BRIEF DESCRIPTION OF THE DRAWINGS

FIGS. 1A and 1B are diagrams illustrating a general outline of a light deflecting element according to a first embodiment;

FIGS. 2A and 2B are schematic diagrams that schematically illustrate the function of deflecting laser beams that is implemented by the light deflecting element according to the first embodiment;

FIG. 3 is a configuration diagram illustrating a general outline of a light deflecting element according to a comparison example with respect to the light deflecting element according to the first embodiment;

FIGS. 4A and 43 are schematic diagrams that schematically illustrate the function of deflecting laser beams that is implemented by the light deflecting element according to the comparison example;

FIGS. 5A to 5C are diagrams illustrating a general outline of a light deflecting element, according to a second embodiment;

FIGS. 6A and 6B are schematic diagrams that schematically illustrate the function of deflecting laser beams that is implemented by the light deflecting element according to the second embodiment;

FIGS. 7A and 7B are diagrams illustrating a general outline of a light deflecting element according to a third embodiment;

FIGS. 8A to 8C are diagrams illustrating a general outline of a light deflecting element according to a fourth embodiment;

FIGS. 9A and 9B are diagrams illustrating a general outline of light deflecting elements according to a fifth embodiment and a sixth embodiment;

FIG. 10 is a diagram illustrating a first configuration example for moving an optical spot; and

FIG. 11 is a configuration diagram illustrating a second configuration example for moving an optical spot.

### DETAILED DESCRIPTION

According to an embodiment, a light deflecting element includes a dielectric body, a first electrode, a second electrode, and a third electrode. The dielectric body has a first surface and a second surface facing each other, and has an electro-optic effect. The first electrode is disposed on the first surface. The second electrode is configured to sandwich the dielectric body with the first electrode so as to apply a voltage to the dielectric body. The second electrode is disposed on the second surface. The third electrode is configured to sandwich the dielectric body with the first electrode so as to apply a voltage to the dielectric body. The third electrode is disposed on the second surface. The second electrode includes one or more electrodes each having a side that is positioned on a light beam incident side of the dielectric body that allows the light beam to pass and that lies substantially orthogonal to an incident direction of the light beam, a side that is substantially parallel to the incident direction of the light beam, and a side that is positioned on the light beam outgoing side and that intersects with the light beam. The third electrode includes one or more electrodes each having a side that is aligned with the second electrode on the light beam incident side and that lies substantially orthogonal to the incident direction of the light beam, a side that is substantially parallel to the incident direction of the light beam, and a side that is positioned or the light beam outgoing side, that intersects with the light beam, and that slopes in an opposite to that of the side of the second electrode that intersects with the light beam.

Prior to explaining a light deflecting element according to embodiments; firstly, the explanation is given regarding the relationship between a light deflecting element and an optical spot.

For example, an optical spot is formed by collecting the light of a laser beam. If an optical spot is brought close to the wavelength diffraction limit and is reduced in size, then that optical spot can have a wide array of uses. In order to deflect an optical spot formed by collecting the light of a laser beam; generally, it is necessary to make use of the following: an objective lens that focuses the laser beam; a laser beam that fails on the objective lens; and a light deflecting element that adjusts the angle of incidence of the laser beam with respect to the objective lens.

Thus, by making use of a light deflecting element to adjust the angle of incidence of a laser beam with respect to an objective lens, it becomes possible to change the positions of an optical spot that is formed by the objective lens by collecting the light of a laser beam. Herein, in order to ensure that the optical spot is nearly at the wavelength diffraction limit, it is necessary to make use of an objective lens having a large numerical aperture (na), which is expressed using Equation (1) given below.

na=φ/2{square root over ({f²+(Φ²/4))}} (1)

where f is a focal length of objective lens and φ is a diameter of the lens.

In that case, if is known that a size d of the optical spot is expressed using Equation (2) given below.

d=2.44λ/na (2)

where λ is a wavelength.

Thus, the greater the numerical aperture (na), the smaller can be the optical spot that is formed. In other words, when the focal length f of the objective lens is constant; then the greater the diameter φ of the objective lens, the smaller can be the optical spot that is formed.

On the other hand, in order to form an optical spot that has the size expressed using Equation (2), it is necessary that the laser beam that is incident on the objective lens falls on the entire pupil of the objective lens. It is necessary that the diameter of the incident laser beam is equal to or greater than the diameter φ of the objective lens. From this, it can be noticed that, in order to form a small-sized optical spot, it is necessary to increase the diameter of the incident laser beam.

Meanwhile, if “θ” represents the gradient, of the principal ray of the laser beam that is incident on the objective lens (i.e., if “θ” represents the angle of deflection of the laser beam due to a light deflecting element), then a range s that enables focusing of the optical spot (i.e., a scan distance s) is expressed using Equation (3).

s=f·tan(θ) (3)

Thus, the greater the angle of deflection θ and the longer the focal length f, the greater can be the scan distance s that is obtained.

Herein, for the sake of simplicity, the explanation regarding the scan, distance s is given with reference to a collimated laser beam. Assume that a laser beam having a diameter φ1 is deflected, by an angle of deflection θ by a light deflecting element, and is then expanded to have a diameter φ2 before being collected on an objective lens that has the diameter φ2 and the focal length f. In that case, the scan distance s is expressed using Equation (4) given below.

s=f·tan(θ·φ1/φ2) (4)

Particularly, when “θ·φ1/φ2” is small, the scan distance s is expressed using Equation, (5) if paraxial approximation is applied.

s=f·θ·φ1/φ2=θφ1·\sqrt{(1−na²)}/(2·na) (5)

Thus, when the numerical aperture (na) of the objective lens is constant, it can be noticed that the greater the angle of deflection θ of the light, deflecting element and the greater the diameter φ1 of the laser beam that is deflected, the better it is for the purpose of increasing the scan distance s of the optical spot.

Explained below is the frequency characteristic of a light deflecting element. At present, as a light deflecting element, that adjusts the direction of light, following types are available: a micro electro mechanical systems (MEMS) scanner, a resonant scanner, an electro-optic scanner, and an acousto-optic scanner. However, a MEMS scanner or a resonant scanner is a light deflecting element in which the mirror needs to be mechanically swung in order to adjust the direction of light. Hence, using such a light deflecting element, it is difficult to deflect the light at high speed, and the modulatable frequency is only up to about 1 MHz.

A commonly-used bulk electro-optic element does not have a mechanically-operated portion. Hence, in principle, a bulk electro-optic element can be driven at nigh speed. However, in practice, in order to deflect light, it is necessary to have a high voltage ranging from a few hundred V to a few kv. At such a nigh voltage, it is difficult to perforin modulation at high speed. Moreover, in order to achieve a high speed at a high voltage, if is necessary to make use of a large-scale power circuit. Thus, generally, the modulatable frequency is limited to about a few MHz.

An acousto-optic scanner deflects light by making use of Bragg reflection by acoustic waves. In this method, depending on conditions such as concentrating the laser beam to 100 μm or less, it becomes possible to perform modulation at about tens of MHz. However, due to the sonic velocity limit, it is difficult to perform deflection control at higher speeds. Moreover, in order to achieve a high speed; in principle, the laser beam needs to be narrowly-concentrated to 100 μm or less. That leads to a decrease in the number of resolvable spots. Besides, the diffraction efficiency goes down thereby resulting in a poor usage efficiency of the light. Hence, achieving higher speeds is a not an easy task.

At present, a waveguide electro-optic deflecting element (a light deflecting element) is known to enable deflection of light at high speed. This element is a type of the electro-optic elements. In a waveguide electro-optic deflecting element, a planar waveguide is formed by forming cladding layers above and below a core, which is made of a material having the electro-optic effect. Thus, the light is guided while being confined inside the core layer. Moreover, in a waveguide electro-optic deflecting element; a ground electrode is formed on the entire lower surface, and prism electrodes are formed on the upper surface of the element.

In a waveguide electro-optic deflecting element, when a voltage is applied between the electrodes, an electric field is impressed on the electro-optic material of the core portion that is sandwiched between the ground electrode and the prism electrodes. As a result, the portion that is sandwiched between the electrodes undergoes variation due to the electro-optic effect. Because of a voltage applied between the electrodes, prism-like regions having a different refractive index get formed in the core portion. For that reason, the waveguide electro-optic deflecting element functions as a light deflecting element that is capable of bending the guided light by means of refraction.

Herein, since the refractive index of an electro-optic material changes in proportion to the electric field impressed on that electro-optic material, a light guiding element can deflect light in proportion to the electric field. Moreover, the shorter the distance between the electrodes, greater can be the angle of deflection that is achieved at a low voltage.

Since a waveguide electro-optic deflecting element has a planar waveguide structure, the distance between the ground electrode and the prism electrodes can be shortened to 10 μm or less. Consequently, the required voltage for light deflection can be reduced to few tens of volts or less. Therefore, the waveguide electro-optic deflecting element becomes able to perform high-speed modulation. Depending on conditions, it also becomes possible to achieve an operation speed of about 1 GHz.

Thus, if a waveguide electro-optic deflecting element can be used to deflect a strong light having the diameter φ, it becomes possible to move a small optical soot at high speed over a wide range.

However, regarding a waveguide electro-optic deflecting element, since the light deflecting element itself has the planar waveguide structure, the laser beam having a Gaussian beam shape cannot be deflected without change. That is, in order to move a small optical spot at high speed over a wide range, the laser beam needs to once fail on the planar waveguide and then a sheet-like laser beam that is emitted upon deflection needs to be shaped into a laser beam having a substantially round cross-sectional surface.

More particularly, the laser beam having a Gaussian beam shape needs to be concentrated using a cylindrical lens to a sheet-like laser beam that is made to fall on a planar waveguide. Then, the sheet-like laser beam that is emitted upon deflection needs to be shaped using a cylindrical lens or an anamorphic lens into a laser beam having a substantially round cross-sectional surface. In that case, the diameter φ of the laser beam can be considered to be equal to a laser width w (i.e., w=φ is satisfied). Thus, for example, in the case when na is equal to 0.85, it is ensured that Equation (6) given below is satisfied in order to achieve the scan distance of ±5 μm.

θ·φ=s·2na/\sqrt{(1−na²)}=16 μm (6)

Consequently, when the angle of deflection θ of the light deflecting element is 2°, then a required element width w of the light deflecting element is expressed using Equation (7) given below.

w=16/{(2/180)×3.1415}≈458 μm (7)

In way, in order to move an adequately small optical spot for a considerable distance, it becomes essential for a light deflecting element, to deflect a wide laser beam of few hundred μm or more. However, in a typical waveguide electro-optic deflecting element, the electrodes need to be of a larger size in order to be able to deflect a wide laser beam. Hence, it becomes difficult to perform high-speed operations at the same time.

More particularly, the inter-electrode electric capacitance serves as a contributing factor in determining the operating frequency in a waveguide electro-optic deflecting element. Specifically, since a waveguide electro-optic deflecting element has the structure similar to a capacitor, the equivalent circuit thereof is expressed using the electric capacitance of the electrodes and the parasitic resistance that is series-connected. In the case of driving a waveguide electro-optic deflecting element by applying a high frequency, the cutoff frequency (f_{c}) is expressed using Equation (8) given below,

f_{c}=1/(2πCR) (8)

Herein, “C” represents an inter-electrode electric capacitance and “R” represents a series resistance component. The inter-elect rode electric capacitance C is expressed using Equation (9) given below.

C=∈S/d (9)

In Equation (9), “∈” represents the inter-electrode electric permittivity, “S” represents the electrode area, and “d” represents the electrode interval. In order to focus the electric field as much as possible on the core layer that is made of an electro-optic material, it is desirable that the cladding layer is a conductive material. If the cladding layer is a conductive material, then the inter-electrode electric permittivity ∈ substantively serves as the electric permittivity of the core layer.

Thus, in a waveguide electro-optic deflecting element; if the electrode area is increased in order to deflect a wide laser beam, then the cutoff frequency grows smaller thereby making it difficult to perform high-speed modulation. Moreover, in a waveguide electro-optic deflecting element; if the electrode interval is shortened, the inter-electrode electric capacitance increases. Consequently, in the end, the cutoff frequency grows smaller.

In the example described above, in the case when na is equal to 0.85, in order to achieve the scan distance of ±5 μm, a laser beam having the width of about 500 μm needs to be deflected by about 2° at a low voltage. In that case, if, for example, LiNbO₃ is used as the core material; then a triangular electrode (a prism electrode) having the size of about 500 (μm)×5000 (μm) is required to deflect a laser beam having the width of about 500 μm by about 2°. Then, the cutoff frequency decreases to an extremely small value of about 5 MHz.

### First Embodiment

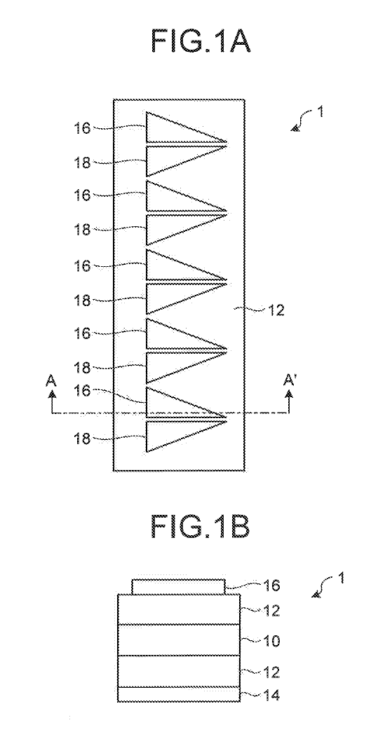

Described below with reference to the accompanying drawings is a first embodiment of a light deflecting element. FIG. 1 is a configuration diagram illustrating a general outline of a light deflecting element 1 according to the first embodiment. FIG. 1A is a top view illustrating the general outline of the light deflecting element 1 when viewed from top. FIG. 1B is a schematic diagram, of a cross-sectional surface taken along line A-A′ from the general outline of the light deflecting element 1 illustrated in FIG. 1A.

The light deflecting element 1 has a planar waveguide structure that includes a core 10, which is made of a dielectric body having the electro-optic effect, and includes cladding layers 12, which are formed above and below the core 10. Moreover, a ground electrode 14 is formed on the lower surface of the light deflecting element 1; while a plurality of prism electrodes 16 and a plurality of prism electrodes 18 having the shape of right triangles are formed on the upper surface of the light deflecting element 1. With that, the light deflecting element 1 is configured to be a waveguide electro-optic deflecting element.

In the light deflecting element 1, the direction of spontaneous polarisation of the core 10 is set in the thickness direction of the planar waveguide structure. More particularly, the core 10 is subjected to polarisation treatment, in such a way that the entire core 10 uniformly polarizes either upward or downward with respect to the thickness direction. The core 10 is made of, for example, a material containing LiNbO₃ and LiTaO₃ and having MgO added thereto. Alternatively, the core 10 can also be made of PLZT ((PbLa)(ZrTi)O₃).

The prism electrodes 16 as well as the prism electrodes 18, which are formed on top of the upper cladding layer 12, are disposed, for example, to have the long sides thereof parallel to each other. Moreover, the long sides of the prism electrodes 16 as well as the long sides of the prism electrodes 18 are set to be parallel with respect to the laser beam, incident on the light deflecting element 1. Alternatively, the prism electrodes 16 and the prism electrodes 18 can be disposed in such a way that the short sides thereof are parallel to each other or in such a way that the short side of the prism electrodes 16 is parallel to the long side of the prism, electrodes 18 or vise versa. Meanwhile, the prism electrodes 16 and the prism electrodes 16 are alternately arranged in a direction that intersects with the incident direction of the laser beam.

The oblique sides (sloping portions) of the prism electrodes 16 as well as the prism electrodes 18 slope with respect to the incident direction of the laser beam that falls on the light deflecting element 1. Moreover, the prism electrodes 16 and the prism electrodes 18 are so arranged that the oblique sides of the prism, electrodes 16 slope in the opposite direction to that which the oblique sides of the prism electrodes 18 slope across the axis extending in the incident direction of the laser beam. Each prism electrode 16 as well as each prism electrode 18 is so designed that the acute angle of the right triangle is equal to, for example, “φ”.

Herein, it is assumed that the voltage applied, to the prism electrodes 18 and the voltage applied to the prism electrodes 18 have, for example, opposite polarities but the same absolute value. In that case, for example, with respect to the core 10 that is sandwiched between the prism electrodes 16 and the ground electrode 14, the prism, electrodes 16 form an electric field in the same direction as the direction of spontaneous polarization of the core 10. Then, since the direction of spontaneous polarization of the core 10 is uniform; with respect to the core 10 that is sandwiched between the prism electrodes 18 and the ground electrode 14, the prism electrodes 18 form an electric field in the opposite direction to the direction of spontaneous polarization of the core 10.

Thus, when an electric field in the same direction as the direction of spontaneous polarization is impressed on the prism electrodes 16, an electric field in the opposite direction to the direction of spontaneous polarization is impressed, on the prism electrodes 18. In contrast, when an electric field in the opposite direction to the direction of spontaneous polarization is impressed on the prism electrodes 16, an electric field in the same direction as the direction of spontaneous polarization is impressed on the prism electrodes 18.

As a result, in the regions sandwiched between the prism electrodes 16 and the ground electrode 14 (i.e., first regions), the refractive index of the core 10 changes as illustrated in Equation (10) given below due to the electro-optic effect.

Δn=n₀³r₃₃V/2d (10)

In Equation (10), “Δn” represents the refractive index variation, “n₀” represents the refractive index when there is zero electric field on the core 10, “r₃₃” represents the electro-optic constant, “V” represents the electrode voltage, and “d” represents the inter-electrode distance.

Meanwhile, in the regions sandwiched between the prism electrodes 18 and the ground, electrode 14 (i.e., a second regions), the refractive index of the core 10 changes by −Δn that has the opposite sign to the refractive index variation Δn of the first regions.

As illustrated in FIG. 1, with respect to the incident laser beam, the oblique sides of the prism electrodes 16 slope in the opposite direction to that which the oblique sides of the prism electrodes 18 slope. Thus, the laser beam that passes any one of a first region and a second region is deflected in the same direction. Specifically, the laser beam that passes through any one of a first region and a second region has the angle of deflection θ equal to a value illustrated in Equation (11) given below.

θ=(90−φ)−sin⁻¹{(n₀+Δn)/n₀−sin(90−φ)} (11)

where unit of φ is degree.

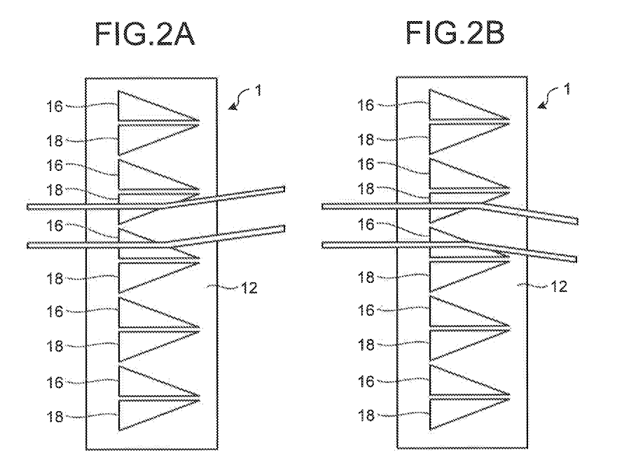

FIGS. 2A and 2B are schematic diagrams that schematically illustrate from above the function of deflecting laser beams that is implemented by the light deflecting element 1 according to the first embodiment. The voltage applied to the prism electrodes 16 and the prism electrodes 18 in FIG. 2A is the inverse voltage of the voltage applied to the prism electrodes 16 and the prism electrodes 18 in FIG. 2B. As illustrated in FIGS. 2A and 2B, the laser beam that fails on the region sandwiched between a prism electrode 16 and the ground electrode 14 (i.e., the first region) is deflected in the same direction in which is deflected the laser beam that falls on the region sandwiched between a prism electrode 18 and the ground electrode 14 (i.e., the second region).

Moreover, since the oblique sides of the prism electrodes 16 slope is in the opposite direction to that which the oblique sides of the prism electrodes 18 slope, the laser beam deflected in the first region and the laser beam deflected in the second region do not interfere with each other. Meanwhile, each prism electrode 16 is, for example, in the shape of a congruent right triangle. Similarly, each prism electrode 18 is, for example, in the shape of a congruent right triangle. In this way, with a smaller electrode area as compared to the electrode area of a single electrode in the shape of a large right triangle, the light deflecting element 1 can deflect a wide laser beam having the width w in a substantially uniform manner. For that reason, it becomes possible to move a small optical spot at high speed over a long distance.

As a specific example of the sizes, for example, the prism electrodes 16 are in the shape of right triangles having the short side of 20 μm, the long side of 120 μm, and the acute angle φ of 9.46°. The prism electrodes 18 are in the shape of right triangles that are axisymmetric to the prism electrodes 16, with the axis extending in the incident direction of the laser beam serving as the target axis. In the light deflecting element 1, 15 of the prism electrodes 16 and 15 of the prism electrodes 18 are alternately arranged in a direction that intersects with the incident direction of the laser beam, and a laser beam having the width of 500 μm can be deflected. Herein, in the light deflecting element 1, for example, if a voltage of 50 V is applied to the prism electrodes 16 and a voltage of −50 V is applied to the prism electrodes 18; then a laser beam that has the width of 500 μm and that falls on the light deflecting element 1 is deflected by 1.4°. If that laser beam is collected in an optical spot with the use of a lens having the numerical aperture (na) equal to 0.85, it becomes possible to achieve a scan amount having the width of ±3.8 μm. Meanwhile, with, the prism electrodes 16, the prism electrodes 18, and the ground electrode 14; the capacitance is 7 pF and the cutoff frequency is 325 MHz.

As another specific example of the sizes, for example, the prism electrodes 16 are in the shape of right triangles having the short side of 20 μm, the long side of 60 μm, and the acute angle φ of 18.4°. The prism electrodes 18 are in the shape of right triangles that are axisymmetric to the prism electrodes 16, with the axis extending in the incident direction of the laser beam serving as the target, axis. In the light deflecting element 1, ten of the prism, electrodes 16 and ten of the prism electrodes 18 are alternately arranged in a direction that intersects with the incident direction of the laser beam, and a laser beam having the width of 300 μm can be deflected. Herein, in the light deflecting element 1, for example, if a voltage of 50 V is applied to the prism electrodes 16 and a voltage of −50 V is applied to the prism electrodes 18; then a laser beam, that has the width of 300 μm and that falls on the light deflecting element 1 is deflected by 0.7°. If that laser beam is collected in an optical spot with the use of a lens having the numerical aperture (na) equal to 0.85, it becomes possible to achieve a scan amount having the width of ±1.1 μm. Meanwhile, with the prism electrodes 16, the prism electrodes 18, and the ground electrode 14; the capacitance is 2.3 pF and the cutoff frequency is 972 MHz. Thus, with the scan amount of ±1.1 μm, the light deflecting element 1 can deflect a laser beam at a frequency of nearly 1 GHz.

### First Comparison Example

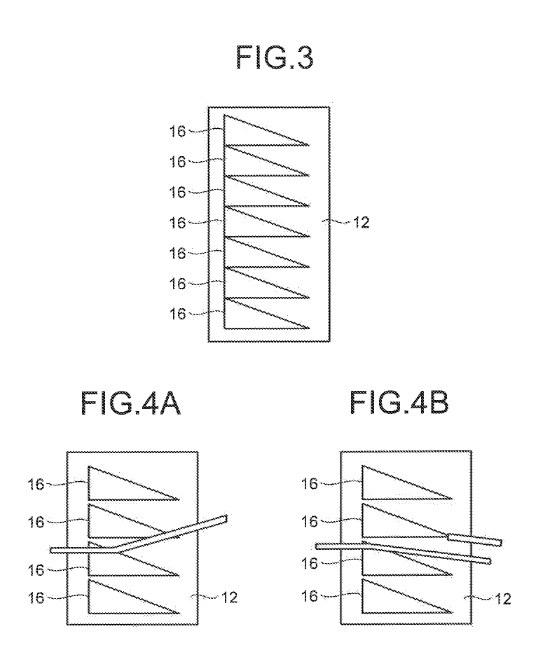

FIG. 3 is a configuration diagram illustrating a general outline of a light deflecting element according to a first comparison example with respect to the light deflecting element 1. In the light deflecting element according to the first comparison example illustrated in FIG. 3, the constituent elements that are substantively identical to the constituent elements in the light deflecting element 1 illustrated in FIGS. 1A and 1B are referred to by the same reference numerals. As illustrated in FIG. 3, in the light, deflecting element according to the first comparison example, only one type of prism electrodes, such as the prism electrodes 16, are arranged on the upper surface. Thus, in the first, comparison example, the electrodes formed in the shape of right triangles have oblique sides that slope in only one direction.

FIGS. 4A and 4B are schematic diagrams that schematically illustrate from above the function of deflecting laser beams that is implemented by the light deflecting element according to the first comparison example illustrated in FIG. 3. The voltage applied to the prism electrodes 16 in FIG. 3A is the inverse voltage of the voltage applied to the prism electrodes 16 in FIG. 4B. As illustrated in FIG. 4A, the laser beam, deflected in the first region, which is formed by a single prism electrode 16, falls on another first region formed by another prism electrode 16. As illustrated in FIG. 4B, in the light deflecting element according to the first comparison example, depending on the direction of deflection of a laser beam, a dark portion (shade; gets formed in the deflected laser beam. Thus, in the light deflecting element according to the first comparison example, a uniform deflected state of the laser beam cannot be achieved in entirety. Hence, it is difficult to focus the laser beam to an optical spot size close to the diffraction limit.

### Second Comparison Example

In a second comparison example, it is assumed that prism electrodes formed in the shape of right triangles have oblique sides that slope in only one direction in an identical manner to the first comparison example illustrated in FIG. 3. However, in the second comparison example, it is assumed that only a single electrode in the shape of a right triangle (not illustrated) deflects the incident laser beam. More particularly, a single prism electrode 16 is disposed that, is in the shape of a right triangle having the short side of 600 μm, the long side of 3600 μm, and the acute angle φ of 9.46°, and a laser beam having the width of 500 μm can be deflected. In the second, comparison example, for example, if a voltage of 50 V is applied to that prism electrode 16, then an incident laser beam having the width of 500 μm is deflected by 1.4°. If that laser beam is collected in an optical spot with the use of a lens having the numerical aperture (na) equal to 0.85, it becomes possible to achieve a scan amount having the width of ±3.8 μm. However, due to the prism electrode 16 and the ground electrode 14, the capacitance increases to a large amount of 210 pF and the cutoff frequency becomes 10.8 MHz. Hence, as compared to the light deflecting element 1 according to the first embodiment, there occurs a delay by a single digit to close to two digits.

### Second Embodiment

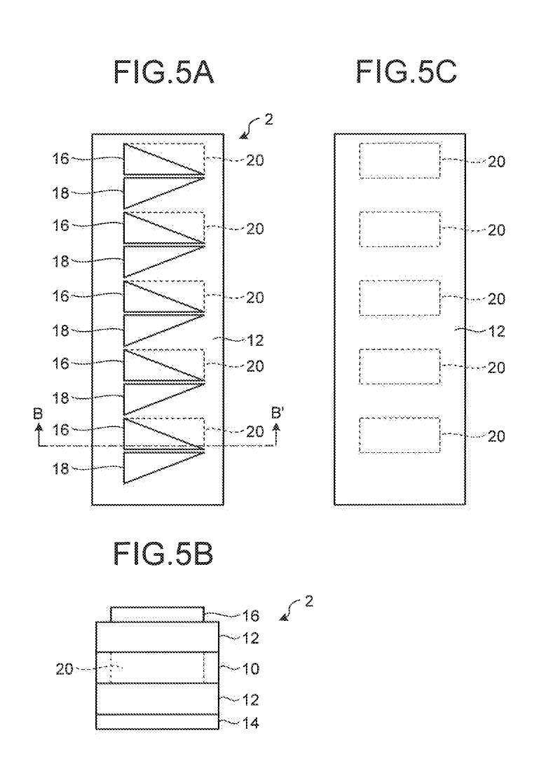

FIGS. 5A to 5C are diagrams illustrating a general outline of a light deflecting element 2 according to a second embodiment. FIG. 5A is a top view illustrating the general outline of the light deflecting element 2 when viewed from top. FIG. 5B is a schematic diagram of a cross-sectional surface taken along line B-B′ from the general outline of the light deflecting element 2 illustrated in FIG. 5A. FIG. 5C is a diagram that schematically illustrates a condition in which, the prism electrodes 16 and the prism electrodes 18 are removed from the light deflecting element 2 illustrated in FIG. 5A. Meanwhile, in the light deflecting element 2 illustrated in FIGS. 5A to 5C, the constituent elements that are substantively identical to the constituent elements in the light deflecting element 1 illustrated in FIGS. 1A and 1B are referred to by the same reference numerals.

In an identical manner to the light deflecting element 1, the light deflecting element 2 has the basic structure of a waveguide electro-optic deflecting element. The direction of spontaneous polarization of the core 10 is set in the thickness direction of the planar waveguide structure, however, reverse polarization regions 20 that are the regions that, are sandwiched between the prism electrodes 16 and the ground electrode 14 are subjected to polarization treatment in such a way that the reverse polarization regions 20 polarize in the opposite direction than the other regions of the core 10.

For example, the regions between the prism electrodes 16 and the ground electrode 14 are subjected to polarization treatment so as to perform upward polarization, while the regions between the prism electrodes 18 and the ground electrode 14 are subjected to polarisation treatment so as to perform downward polarization. Moreover, the prism electrodes 16 and the prism electrodes 18 are alternately arranged in a direction that intersects with the incident direction of the laser beam, and the prism electrodes 16 and the prism electrodes 18 are applied, with the same voltage in the same direction as the direction of spontaneous polarization of the regions sandwiched between the prism electrodes 18 and the ground electrode 14.

In other words, the regions that are sandwiched between the prism electrodes 18 and the ground electrode 14 are applied with, a voltage in the same direction as the direction of spontaneous polarisation. However, the regions that are sandwiched between the prism electrodes 16 and the ground electrode 14 are applied with a voltage in the opposite direction to the direction of spontaneous polarisation.

As a result, when the refractive index of the core 10 in the regions sandwiched between the prism electrodes 18 and the ground electrode 14 changes by Δn, the refractive index of the core 10 in the regions sandwiched between the prism electrodes 16 and the ground electrode 14 changes by −Δn.

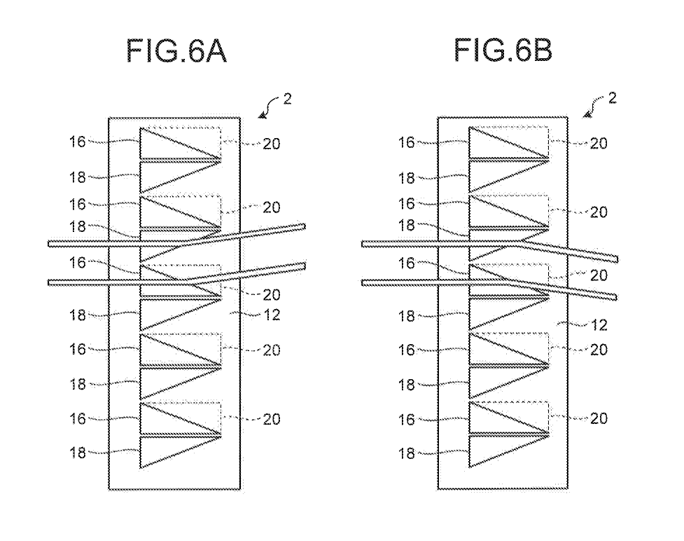

FIGS. 6A and 6B are schematic diagrams that schematically illustrates from above the function of deflecting laser beams that is implemented by the light deflecting element 2 according to the second embodiment. The voltage applied to the prism electrodes 16 and the prism electrodes 18 in FIG. 6A is the inverse voltage of the voltage applied to the prism electrodes 16 and the prism electrodes 13 in FIG. 6B. As illustrated in FIGS. 6A and 6B, the laser beam that falls on the regions sandwiched between the prism, electrodes 16 and the ground electrode 14 is deflected in the same direction in which is deflected the laser beam that fails on the regions sandwiched between the prism electrodes 18 and the ground electrode 14. Thus, in an identical manner to the light deflecting element 1, the light deflecting element 2 deflects a wide laser beam having the width w in a substantially uniform manner.

### Third Embodiment

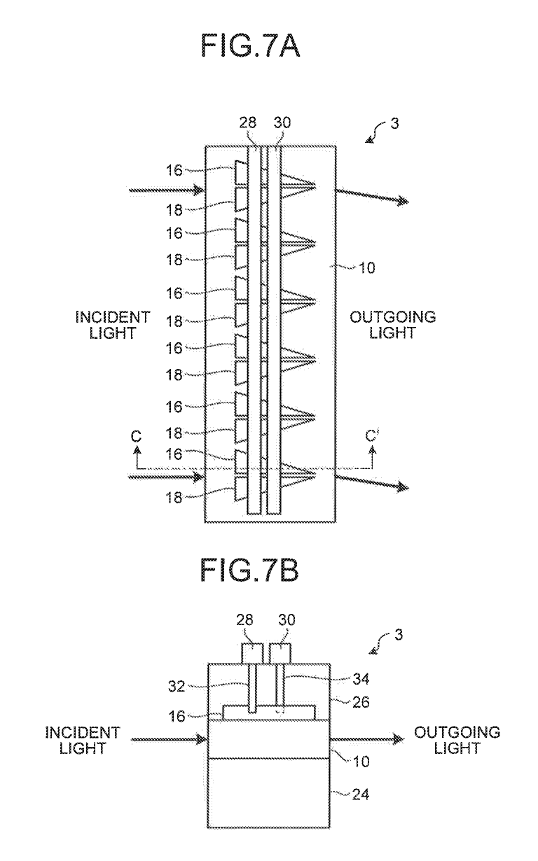

FIGS. 7A and 7B are diagrams illustrating a general outline of a light deflecting element 3 according to a third embodiment. FIG. 7A is a top view illustrating the general outline of the light deflecting element 3 when viewed from top. FIG. 7B is a schematic diagram of a cross-sectional surface taken along line C-C from the general outline of the light deflecting element 1 illustrated in FIG. 7A. Meanwhile, in the light deflecting element 3 illustrated in FIGS. 7A and 7B, the constituent elements that are substantively identical to the constituent elements in the light deflecting element 1 illustrated in FIGS. 1A and 1B are referred to by the same reference numerals. Moreover, in FIG. 7A, an embedded layer 26 that is illustrated in FIG. 7B is not illustrated.

The light deflecting element 3 is manufactured by attaching a stainless substrate 24, which has a small difference in coefficient, of thermal expansion, to an LiNbO₃:MgO monocrystalline substrate, which forms the core 10, and then by performing grinding until a small thickness of 2 μm is achieved. Meanwhile, the light, deflecting element 3 does not have the cladding layers 12 that are illustrated in FIGS. 1A and 1B and has a single-slab waveguide structure of LiNbO₃:MgO. Moreover, in the light deflecting element 3, the stainless substrate 24 serves as a ground electrode.

Once the light deflecting element 3 is grinded to the thickness of 2 μm, the prism electrodes 16 and the prism electrodes 18 are formed on the upper surface of the core 10 by means of the liftoff technique. The prism electrodes 16 are, for example, in the shape of right triangles having the short side of 50 μm, the long side of 300 μm, and the acute angle φ of 9.46°. The prism electrodes 18 are in the shape of right triangles that are axisymmetric to the prism electrodes 16, with the axis extending in the incident direction of the laser beam serving as the target axis. The prism electrodes 16 and the prism electrodes 18 are alternately arranged in a direction that intersects with the incident direction of the laser beam.

In the light deflecting element 3, there are six prism, electrodes 16 and six prism electrodes 18; and a laser beam having the width of 500 μm can be deflected. Each prism electrode 16 as well as each prism electrode 18 has, for example, a two-layered structure containing Chromium (Cr) of 10 nm and gold (Au) of 50 nm.

in the light deflecting element 3, the prism electrodes 16 and 18 are embedded in the embedded layer 26 that is made of, for example, SiO₂ of 1 μm; and the top face of the embedded layer 26 is planarized. Then, wires 28 and 30 are laid on the embedded layer 26. The wire 28 is connected to the prism electrodes 16 through a via hole 32, while the wire 30 is connected to the prism electrodes 13 through a via hole 34.

In the light deflecting element 3, for example, if a voltage of 50 V is applied, to the prism electrodes 16 and a voltage of −50 V is applied to the prism electrodes 18; then a laser beam that has the width of 500 μm and that fails on the light deflecting element 3 is deflected by 1.4°. If that laser beam is collected in an optical spot with the use of a lens having the numerical aperture (na) equal to 0.85, it becomes possible to achieve a scan amount having the width of ±3.8 μm. Meanwhile, with the prism electrodes 16, the prism electrodes 18, and the ground electrode 14; the capacitance is 17.5 pF and the cutoff frequency is 130 MHz.

### Fourth Embodiment

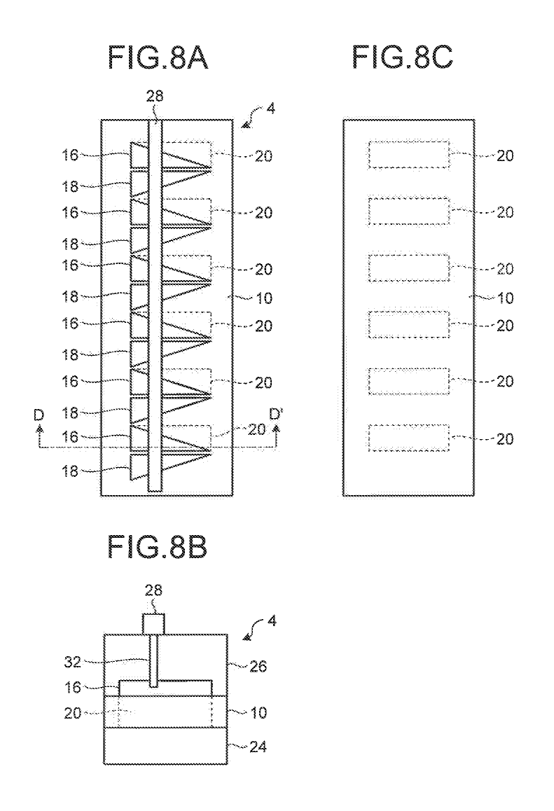

FIGS. 8A to 8C are diagrams illustrating a general outline of a light deflecting element 4 according to a fourth embodiment. FIG. 8A is a top view illustrating the general outline of the light deflecting element 4 when viewed from top. FIG. 8B is a schematic diagram of a cross-sectional surface taken along line D-D′ from the general outline of the light deflecting element 4 illustrated in FIG. 8A. FIG. 80 is a diagram that schematically illustrates a condition in which the prism electrodes 16, the prism electrodes 18, and the wire 23 are removed from the light deflecting element 4 illustrated in FIG. 8A. Meanwhile, in the light deflecting element 4 illustrated in FIGS. 8A to 8C, the constituent elements that are substantively identical to the constituent elements in the light deflecting element 3 illustrated in FIGS. 7A and 7B are referred to by the same reference numerals. Moreover, in FIGS. 8A and 8G, the embedded layer 26 that is illustrated in FIG. 8B is not illustrated.

The light deflecting element 4 is manufactured by attaching the stainless substrate 24, which has a small difference in coefficient of thermal expansion, to an LiNbO₃:MgO mono-crystalline substrate, which forms the core 10, and then by performing grinding until a small thickness of 2 μm is achieved. Meanwhile, the light deflecting element 4 does not have the cladding layers 12 that are illustrated in FIGS. 1A and 1B and has a single-slab waveguide structure of LiNbO₃:MgO. Moreover, in the light deflecting element 4, the stainless substrate 24 serves as a ground electrode.

Furthermore, in the light deflecting element 4, six reverse polarization regions (polarization inversion regions) 20, which have an oblong shape of 50 (μm)×300 (μm) when viewed from above, are formed at intervals of 100 μm. Once the light deflecting element 4 is grinded to the thickness of 2 μm; an electrode for polarization inversion is formed with respect to the core 10 by means of the liftoff technique, and the reverse polarization regions 20 are formed with the use of the electrode for polarization inversion. Upon the completion of a polarization inversion operation for forming the reverse polarization regions 20, the electrode for polarization inversion is detached from the core 10.

In the light deflecting element 4, when the reverse polarization regions 20 are formed, the prism electrodes 16 and the prism electrodes 18 are formed on the upper surface of the core 10 by means of the liftoff technique. The prism electrodes 16 are, for example, in the shape of right triangles having the short side of 50 μm, the long side of 300 μm, and the acute angle φ of 9.46°. The prism electrodes 18 are in the shape of right triangles that are axisymmetric to the prism electrodes 16, with the axis extending in the incident direction of the laser beam serving as the target axis. The prism electrodes 16 and the prism electrodes 18 are alternately arranged in a direction that intersects with the incident direction of the laser beam.

Herein, the prism electrodes 16 are disposed on such portions of the upper surface of the core 10 on which the reverse polarization regions 20 are formed. In contrast, the prism electrodes 18 are disposed on such portions of the upper surface of the core 10 on which the reverse polarization regions 20 are not formed. In the light deflecting element 4, there are six prism electrodes 16 and six prism electrodes 18; and a laser beam having the width of 500 μm can be deflected. Each prism electrode 16 as well as each prism electrode 18 has, for example, a two-layered structure containing Chromium (Cr) of 10 nm and gold (Au) of 50 nm.

In the light deflecting element 4, the prism electrodes 16 and 18 are embedded in the embedded layer 26 that is made of, for example, SiO₂ of 1 μm, and the top face of the embedded layer 26 is planarized. Then, the wire 28 is laid on the embedded layer 26. The wire 28 is connected to the prism electrodes 16 through the via hole 32.

In the light, deflecting element 4, for example, if a voltage of 50 V is applied to the prism electrodes 15 as well as to the prism, electrodes 18; then a laser beam that has the width of 500 μm and that fails on the light deflecting element 4 is deflected by 1.4°. If that laser beam is collected in an optical spot with the use of a lens having the numerical aperture (na) equal to 0.85, it becomes possible to achieve a scan amount having the width of ±3.8 μm. Meanwhile, with the prism electrodes 15, the prism electrodes 18, and the ground electrode 14; the capacitance is 17.5 pF and the cutoff frequency is 130 MHz.

### Fifth Embodiment and Sixth Embodiment

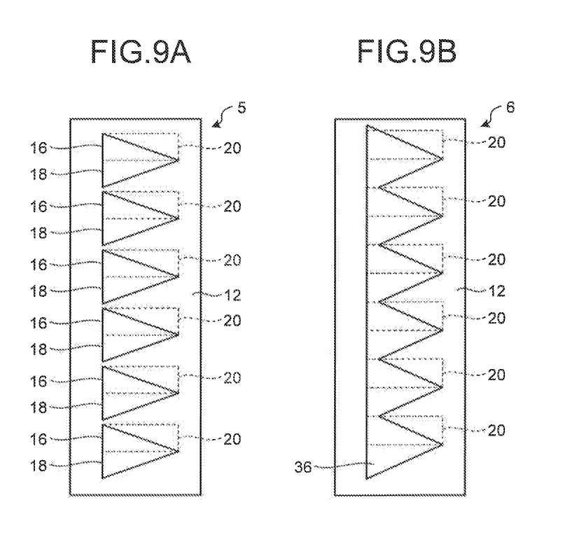

FIGS. 9A and 9B are diagrams illustrating a general outline of a light deflecting element 5 and a light deflecting element 6 according to a fifth embodiment and a sixth embodiment, respectively. FIG. 9A is a top view illustrating the general outline of the light deflecting element 5 when viewed from, top, while FIG. 9B is a top view illustrating the general outline of the light deflecting element 6 when viewed from top. Meanwhile, in the light deflecting elements 5 and 6 illustrated in FIGS. 9A and 9B, the constituent elements that are substantively identical to the constituent elements in the light deflecting element 2 illustrated in FIGS. 5A to 5C are referred to by the same reference numerals.

As illustrated in FIG. 9A, in the light deflecting element 5, integrated sets of a single prism electrode 16 and a single prism electrode 18 are formed, and the same voltage is applied to the prism electrodes in each such integrated set. Thus, the prism electrode 16 and the prism electrode 18 in each integrated set constitute an isosceles triangle, from which a laser beam gets deflected in a substantially identical manner to the manner of deflection in the light deflecting element 2 illustrated in FIGS. 5A to 5C.

As illustrated in FIG. 9B, in the light, deflecting element 6, a single electrode 36 replaces all of the prism electrodes 16 as well as all of the prism electrodes 18 that are disposed in the light deflecting element 5 illustrated in FIG. 9A. The electrode 36 serves as a single electrode in which the prism electrodes 16 and 18 are integrated to overlap each other little by little. The electrode 36 has sloping portions (equivalent to oblique sides) that slope alternately in different directions to the incident direction of the laser beam. Thus, the light deflecting element 6 deflects a laser beam in a substantially identical manner to the manner of deflection in the light deflecting element 2 illustrated in FIGS. 5A to 5C.

Explained below are configuration examples for moving an optical spot (for performing scanning) with the use of the light deflecting element 1 (or any one of the light deflecting element 2 to the light deflecting element 6).

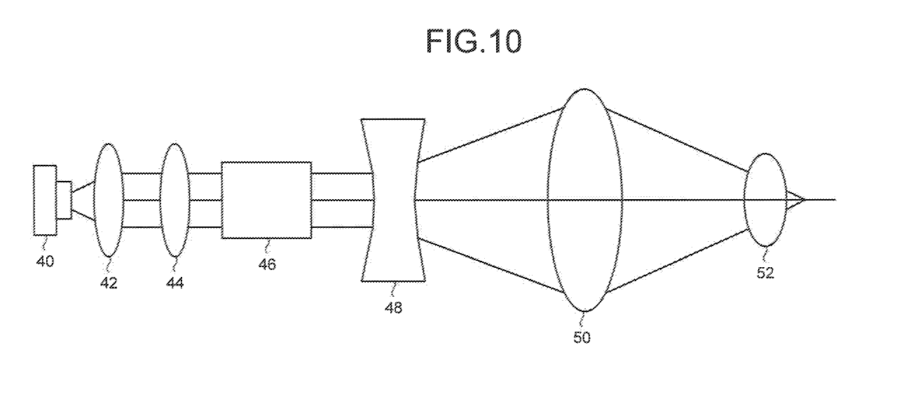

FIG. 10 is a diagram illustrating a first configuration example for moving an optical spot. As illustrated, in FIG. 10, for example, a laser beam emitted by a blue laser diode (LB) 40 is collimated by an anamorphic lens 42 into a beam having the diameter of 500 μm. Then, the collimated laser beam gets concentrated by a cylindrical lens 44 before falling on a deflector 46.

The deflector 46 includes the light deflecting element 1 (or any one of the light, deflecting element 2 to the light deflecting element 6), and emits a laser beam upon deflecting it according to the voltage applied alternately with positive and negative polarities from a power supply unit (not illustrated). The laser beam emitted by the deflector 46 is sheet-dike in shape and diverges in the perpendicular direction with respect to the planar waveguide of the light deflecting element 1. An anamorphic lens 48 shapes the laser beam, which has been emitted by the deflector 46, in such a way that, the laser beam has a substantially round cross-sectional surface. The laser beam shaped by the anamorphic lens 48 passes through a collimator lens 50 and falls on an objective lens 52 having the numerical aperture (na) of 0.85. Then, the objective lens 52 forms an optical spot on a focal plane.

For example, with the drive voltage of 50 V, a laser beam collimated to have the diameter of 500 μm can be deflected by the deflector 46, which includes the light deflecting element 1, by 1.4°. Hence, on the focal plane, a scan distance of ±3.8 μm is achieved.

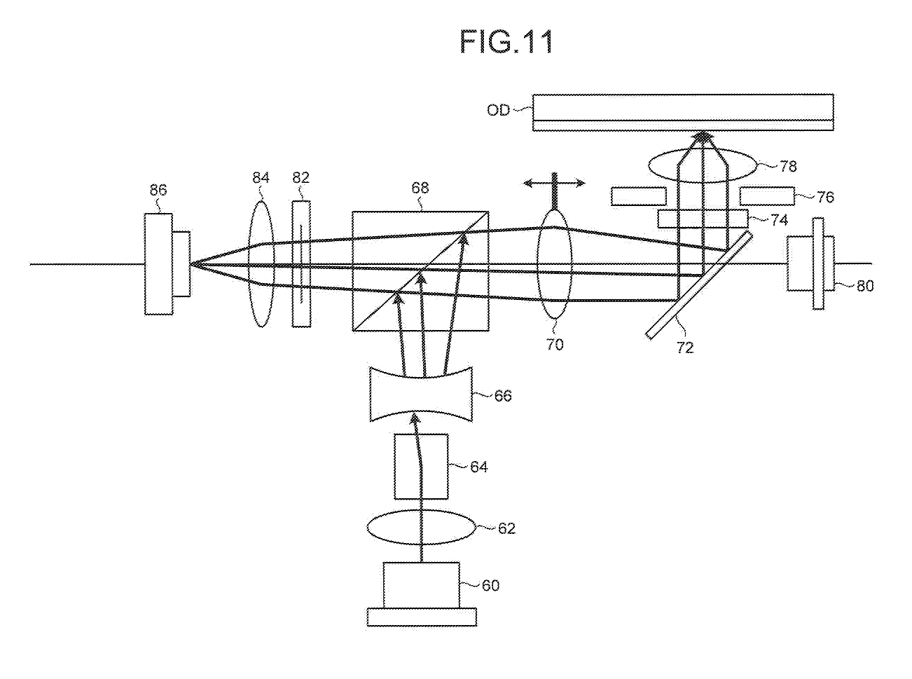

FIG. 11 is a configuration diagram illustrating a general outline of an optical disk device (an optical disk drive) as a second configuration example for moving an optical spot. The optical disk device performs data writing and data reading with respect to the tracks of an optical disk such as a Blu-ray Disc (BD) that is rotated by a rotating mechanism such as a spindle motor (not illustrated).

The optical disk device includes an LD 60, a coupling lens 62, a deflector 64, a concave lens 66, a beam, splitter 68, a collimator 70, a standing mirror 72, a hologram lens 74, an aperture 76, an objective lens 78, a light intensity monitor 80, a hologram filter 82, a collecting lens 84, and a photodiode array 86.

The LD 60 is, for example, a blue laser diode that generates a laser beam and emits it to the coupling lens 62. Herein, the coupling lens 62 is, for example, a cylindrical lens that concentrates the laser beam, which has been emitted by the LD 60, into a sheet-like light (linear light) and guides it to the deflector 64.

The deflector 64 includes the light deflecting element 1 (or any one of the light deflecting element 2 to the light deflecting element 6), and deflects the laser beam according to a voltage applied by a power supply unit, (not illustrated). The concave lens 66 shapes the laser beam, which is emitted by the deflector 64, in such a way that the laser beam has a substantially round cross-sectional surface; and then guides the shaped light to the beam splitter 68.

The beam splitter 68 reflects a portion of the laser beam, which is guided from the concave lens 66, toward the collimator 70. Moreover, the beam splitter 68 isolates the laser beam that is emitted by the LD 60 from, the laser beam that is reflected from the optical disk. The collimator 70 collimates the laser beam, which is received from the beam splitter 68; into a parallel beam of light.

The standing mirror 72 reflects the laser beam, which has passed through the collimator 70, toward the optical disk (OD). The hologram lens 74 isolates the laser beam that is emitted by the LD 60 from the laser beam that is reflected from the optical disk. The aperture 76 is set so as to concentrate the laser beam. The objective lens 78 focuses the laser beam on a track of the optical disk, and forms an optical spot to be used, in data writing and data reading. The light intensity monitor 80 monitors the light intensity of the laser beam.

The laser beam reflected from, the optical disk, gets reflected from the standing mirror 72 and is guided to the hologram, filter 82 through the collimator 70 and the beam splitter 68. The hologram filter 82 shapes the laser beam reflected from the optical disk and guides that laser beam to the collecting lens 84. Then, the collecting lens 84 focuses the laser beam, which, is incident from the hologram filter 82, on the photodiode array 86. Subsequently, the laser beam received by the photodiode array 86 is converted into electric signals that are used, in controlling the deflector 64.

In the optical disk device illustrated in FIG. 11, the objective lens 78 is set to have the numerical aperture (na) of 0.85, which is identical to the objective lens 52 illustrated in FIG. 10. Moreover, on the optical disk, scanning of ±3.8 μm can be performed. Hence, regarding recording tracks that are recorded at a pitch of 0.3 μm, it becomes possible to read 25 tracks daring a single scan.

Thus, while keeping the optical disk rotated at a rate at which 72 Mbps, which is equivalent to twice the rate of a Blu-ray Disc, can be achieved from a single track; the optical disk device that includes the light deflecting element 1 can scan 25 tracks and read them in parallel. As a result, a reading rate of 1.8 Gbps can be achieved.

According to an aspect of the embodiment, with a smaller electrode area as compared to the electrode area of a single electrode in the shape of a large right triangle, it becomes possible to deflect a wide laser beam without causing any interference for the laser beam. For that reason, it becomes possible to deflect a small optical spot at high speed.

While certain embodiments have been, described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fail within the scope and spirit of the inventions.

What is claimed is:

1. A light deflecting element comprising:
a dielectric body having a first surface and a second surface facing each other, the dielectric body having an electro-optic effect;
a first electrode disposed on the first surface; and
a second electrode configured to sandwich the dielectric body with the first electrode so as to apply a voltage to the dielectric body, the second electrode being disposed on the second surface;
a third electrode configured to sandwich the dielectric body with the first electrode so as to apply a voltage to the dielectric body, the third electrode being disposed on the second surface, wherein
the second electrode includes one or more electrodes each having
a side that is positioned on a light beam incident side of the dielectric body that allows the light beam to pass and that lies substantially orthogonal to an incident direction of the light beam,
a side that is substantially parallel to the incident direction of the light beam, and
a side that is positioned on the light beam outgoing side and that intersects with the light beam, and
the third electrode includes one or more electrodes each having
a side that is aligned with the second electrode on the light beam incident side and that lies substantially orthogonal to the incident direction of the light beam,
a side that is substantially parallel to the incident direction of the light beam, and
a side that is positioned on the light beam outgoing side, that intersects with the light beam, and that slopes in an opposite to that of the side of the second electrode that intersects with the light beam.

2. The element according to claim 1, wherein
the second electrode forms one or more first refracting surfaces in the dielectric body for refracting the light beam at a refractive index when a first voltage is applied to a first region of the dielectric body in a direction of polarization of the first region, the first region being sandwiched between the first electrode and the second electrode, and
the third electrode forms one or more second refracting surfaces in the dielectric body for refracting the light beam at a refractive index when a second voltage is applied to a second region of the dielectric body in a direction opposite to a direction of polarisation of the second region, the second region being sandwiched between the first electrode and the third electrode, the one or more second refracting surfaces sloping in a direction opposite to the direction in which the first refracting surfaces slope across an axis extending in the incident direction of the light beam, the first refracting surfaces and the second refracting surfaces being positioned alternately so as to intersect with the incident direction of the light beam.

3. The element according to claim 2, wherein
the second electrode has one or more first sloping portions that slope in a direction that is oblique to the incident direction of the light beam,
the second electrode forms the one or more first refracting surfaces according to the slope of the first sloping portions,
the third electrode has one or more second sloping portions that slope in a direction that is oblique to the incident direction of the light beam, and
the third electrode forms the one or more second refracting surfaces according to the slope of the second sloping portions.

4. The element according to claim 1, wherein the second electrode as well as the third electrode includes one or more electrodes each having a shape of a right triangle and each having a side that is substantially parallel to the incident direction of the light beam.

5. The element according to claim 2, wherein
the first region has the same direction of polarization as the direction of polarization of the second region, and
a direction of the first voltage is opposite to a direction of the second voltage.

6. The element according to claim 2, wherein
the direction of polarization of the first region is opposite to the direction of polarization of the second region, and
a direction of the first voltage is the same as a direction of the second voltage.

7. The element according to claim 6, wherein the second electrode and the third electrode are formed in an integrated manner.

8. The element according to claim 1, wherein the dielectric body is a waveguide that allows light of a predetermined width to pass therethrough.

9. The element according to claim 4, wherein each of the electrodes having the shape of a right triangle is congruent in nature.

10. The element according to claim 2, wherein, when the first voltage and the second voltage have the same absolute value in opposite directions, the light beam refracted at the one or more first refracting surfaces is substantially parallel to the light beam refracted at the one or more second refracting surfaces.
